(19) United States
(12) Patent Application Publication
(10) Pub. No.: US 2008/0061620 A1
(43) Pub. Date: Mar. 13, 2008

(54) SEATBELT ASSEMBLY FOR IMPROVED BELT SAFETY AND COMFORT

(76) Inventor: Basil M. Freeman, Howell, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/852,674

(22) Filed: Sep. 10, 2007

Related U.S. Application Data
(60) Provisional application No. 60/825,334, filed on Sep. 12, 2006.
(60) Provisional application No. 60/825,006, filed on Sep. 8, 2006.

(51) Int. Cl. B60R 22/12; B60R 22/18

(52) U.S. Cl. 297/483

(57) ABSTRACT

An improved ergonomic seatbelt system includes a spool bracket, a longitudinal belt wound about and within the spool bracket. The first and second longitudinal ends of the belt present folded sections. The improved ergonomic seatbelt system provides improved comfort and safety to a passenger. The seatbelt does not require multiple components, thereby reducing cost and simplifying the manufacturing method of the seatbelt. The improved spool design reduces the overall diameter of the wound belt, thereby improving packaging characteristics to fit the spool into a b-pillar or a seat system.

### RELATED APPLICATIONS

This is a non-provisional application that claims priority to provisional applications Ser. Nos. 60/825,334 filed on Sep. 12, 2006 and 60/825,006 filed on Sep. 8, 2006 and incorporated by reference herein in its entirety.

### FIELD OF THE INVENTION

The invention relates generally to seatbelts for automobiles or the like, and more particularly, to an ergonomic seatbelt for improved seatbelt safety and comfort during general use and in the event of seatbelt tensioning during a crash.

### BACKGROUND OF INVENTION

Conventional seatbelts are wide and flat and are generally composed of woven vinyl. Upon a high speed crash, the rough edges of wide and flat seatbelts are likely to cut into the user of the seatbelt. Furthermore, wide and flat seatbelts are likely to cause discomfort at points of contact to users of various sizes. Attempts have been made to provide increased user comfort, but significant disadvantages to these modified seatbelts remain. Modified seatbelts may comprise inflatable seatbelts and/or seatbelt covers.

The art is replete with numerous seat belt designs, which are widely used in the automotive industry today. One of this prior art design is taught by the U.S. Pat. No. 6,217,188 to Takeuchi (the Takeuchi reference). As illustrated in FIG. 5 of the Takeuchi reference, an inflatable seatbelt has a belt body, a cushion layer, and a cover. A gas may be introduced into the belt body, altering the belt away from the wide and flat shape for user comfort.

One exemplary drawback of the Takeuchi reference is that multiple components, namely the cushion layer and cover, are necessary to improve the comfort and feel of the belt, thereby requiring greater manufacturing costs and time. Additionally, the belt body requires inflation to provide comfort and is susceptible to breakage/puncture with repetitive use.

There is a need for an ergonomic seatbelt and method of forming an ergonomic seatbelt for improved safety and comfort that will minimize and/or eliminate the above-identified deficiencies. It would be beneficial to provide a seatbelt which provides comfort to users of various sizes and is capable of long term use without requiring multiple components or inflation, thereby reducing cost and simplifying the manufacturing process of the seatbelt.

As such, there is a need for an improved seat belt assembly that will achieve improved comfort and safety without being configured to inflate, thereby having greater longevity of use, requiring fewer raw materials, and lowering manufacturing costs.

There is also a need for an improved spool design that will reduce the overall diameter of the wound belt, thereby improving packaging characteristics to fit the spool into a b-pillar or a seat system.

### SUMMARY OF THE INVENTION

The present invention provides a seatbelt comprising a longitudinal belt with a longitudinal axis and first and second longitudinal ends on opposite sides of the longitudinal axis. The first and second longitudinal ends comprise folded sections without an edge for providing improved comfort and safety to a user of the seatbelt. The longitudinal belt may comprise woven vinyl. The longitudinal belt may comprise a single thin sheet with opposed longitudinal edges. The longitudinal edges of the thin sheet may be folded under and attached along a generally central portion of the longitudinal belt to define the folded sections of the longitudinal belt. The seatbelt may include stitching in a generally central lengthwise direction of the seatbelt for attaching the longitudinal edges of the thin sheet to form the seatbelt.

The longitudinal belt may comprise a pair of thin sheets with opposed longitudinal edges. Each of the pair of thin sheets may be folded at about a mid-point such that the longitudinal edges of the first thin sheet are enclosed within the longitudinal edges of the second thin sheet and attached along a generally central portion of the longitudinal belt to define the folded sections of the longitudinal belt. The seatbelt may include stitching in a generally central lengthwise direction of the seatbelt for attaching the longitudinal edges of the thin sheets to form the seatbelt.

The longitudinal belt may comprise a thin tube. The tube may be fastened together at a generally central portion of the tube to define the folded sections of the seatbelt. The seatbelt may include stitching in a generally central lengthwise direction of the seatbelt for fastening the tube together to form the seatbelt.

The invention also provides a method of forming a seatbelt for providing improved comfort and safety to a user of the seatbelt. The method may include providing a thin sheet with a longitudinal axis and first and second longitudinal ends on opposite sides of the longitudinal axis. The thin sheet may comprise woven vinyl. The method may also include folding under the first longitudinal end of the thin sheet to form a first folded section of the seatbelt and folding under the second longitudinal end of the thin sheet to form a second folded section of the seatbelt. The method may further include attaching a central portion of the thin sheet, a portion of the thin sheet proximate the first longitudinal end, and a portion of the thin sheet proximate the second longitudinal end together. The attaching step may include stitching in a generally central lengthwise direction of the seatbelt proximate a central portion of the seatbelt.

The invention also provides another method of forming a seatbelt for providing improved comfort and safety to a user of the seatbelt. The other method may include providing a first and second thin sheet with a longitudinal axis and first and second longitudinal ends on opposite sides of the longitudinal axis. The first and second thin sheets may comprise woven vinyl. The method may also include folding the first thin sheet at about a mid-point of the first thin sheet to form a first folded section of the seatbelt and folding the second thin sheet at about a mid-point of the second thin sheet to form a second folded section of the seatbelt. The method may further include inserting the first and second longitudinal ends of the first thin sheet between the first and second longitudinal ends of the second thin sheet. The method may further include attaching the first and second longitudinal ends of the first and second thin sheets together. The attaching step may include stitching in a generally lengthwise direction of the seatbelt proximate a central portion of the seatbelt.

In one aspect of the present invention, the seatbelt is retracted into a sash system. In one embodiment, the sash system includes a single spool. A portion of the seatbelt is wound around the spool.

In another embodiment, the sash system includes two spools cooperable with a spool bracket. The twin-spool design is aimed at saving space. The sash system includes a primary spool and a secondary spool. The sash system further includes an upper spool having a plurality of upper belt sleeve pins rotatably coupled to the spool bracket. The sash system includes a lower spool including a plurality of lower belt sleeves pins. The lower belt sleeve pins are rotatably coupled to the spool bracket.

An ergonomic seatbelt and method of forming a seatbelt in accordance with the present invention are advantageous as compared to existing seatbelts and methods of forming seatbelts.

An advantage of the present invention is to provide an inventive seatbelt and method of forming a seatbelt presenting a device which performs as a safer and more comfortable seatbelt, both as a lap strap and/or shoulder strap, for users of various sizes. The device eliminates edges of conventional wide and flat seatbelts that are likely to cause discomfort due to friction and that may cut into the user of a seatbelt during a high speed crash.

Another advantage of the present invention is to provide the seatbelt that does not require multiple components, thereby reducing cost and simplifying the manufacturing method of the seatbelt.

Still another advantage of the present invention is to provide the seatbelt that does not require inflation, thereby improving the longevity of use of the device, requiring fewer components, and further lowering manufacturing costs.

Still another advantage of the present invention is to provide an improved spool design that reduces the overall diameter of the wound belt, thereby improving packaging characteristics to fit the spool into a b-pillar or a seat system.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a front view of a conventional related art seatbelt;

FIG. 2 is a front view illustrative of an individual wearing a seatbelt;

FIGS. 3A through 3E are cross-sectional views of a related art seatbelt and various embodiments of a seatbelt according to the present invention, respectively;

FIG. 4 is a perspective view illustrative of the seatbelt according to an exemplary embodiment of the present invention;

FIG. 5 is an illustration comparing a sample current spool versus a single spool design for the seatbelt of the present invention;

FIG. 6 is a diagrammatic illustration of a twin spool design of the present invention;

FIG. 7A is a perspective view of a four spool design of the present invention; and

FIG. 7B is a cross sectional view of the four spool design of FIG. 7A.

### DETAILED DESCRIPTION OF THE PREFERRED EMBODIMENT

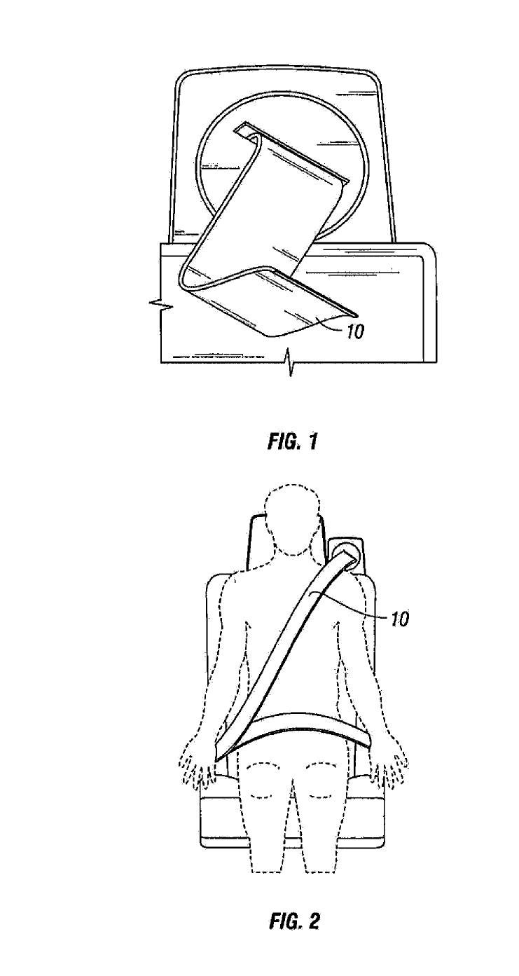

Referring now to the drawings wherein like reference numerals designate corresponding parts throughout the several views, FIGS. 1 through 4 illustrate a related art seatbelt and various embodiments of a seatbelt according to the present invention, respectively.

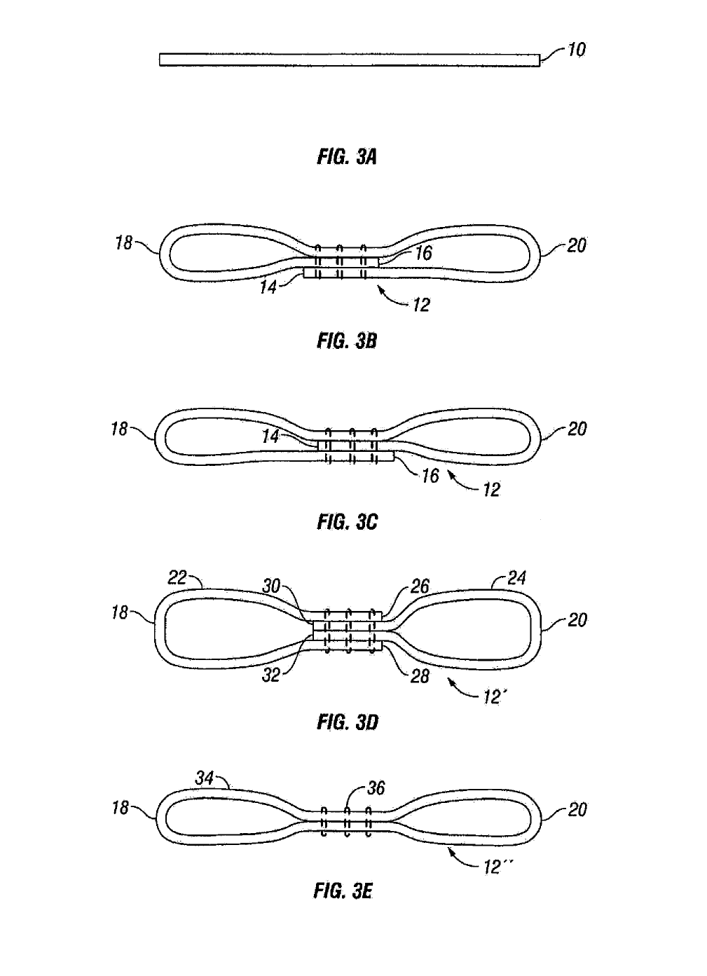

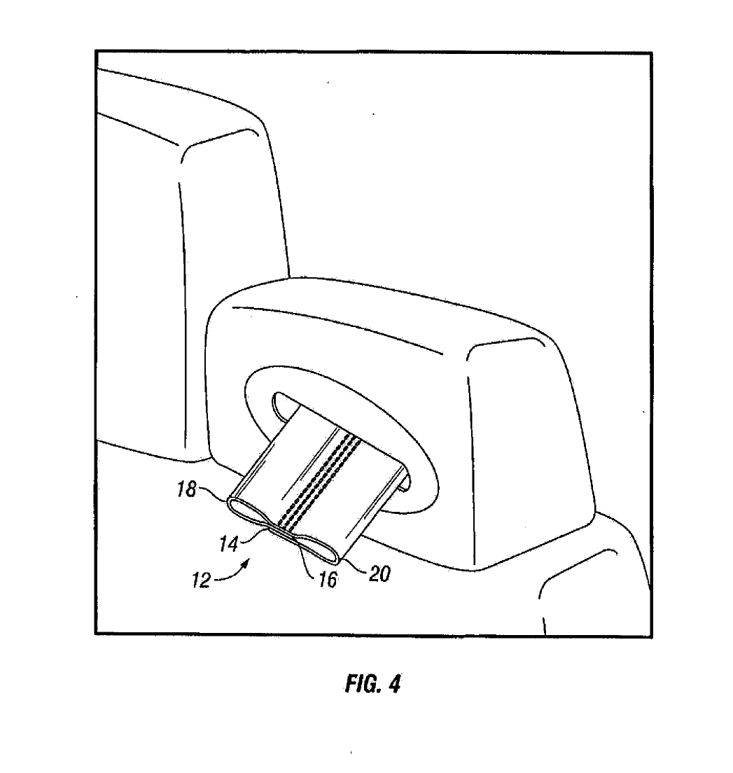

Referring now to FIGS. 1 and 3A, typical seatbelt 10 includes a predetermined width and a thin/flat cross-section. The seatbelt 10 is generally formed of thin stretches of woven vinyl. Conventionally, when in use, the seatbelt 10 is worn across the shoulder-blade and torso of a passenger (shown in phantom lines), as is well known and shown in FIG. 2. The seatbelt 10 illustrated in FIGS. 1 and 3A is problematic in its safety and comfort. From a safety point of view, in the event of a crash, such seatbelts 10 have a tendency to cut or burn the passenger's neck and/or the shoulder-blade area due to friction. Further, such seatbelts 10 also have a tendency to cut the passenger's torso. From a comfort point of view, such seatbelts 10 often irritate the exposed areas of the passenger's neck and/or shoulder-blade areas.

In order to alleviate at least the aforementioned exemplary drawbacks of the conventional seatbelt 10 design, a seatbelt, generally shown at 12, of the present invention is illustrated in details in FIGS. 3B through 3E and 4. As shown in FIGS. 3B through 3C, the seatbelt 12 has the same width as the conventional seatbelt 10 shown in FIG. 3A. However, instead of being formed of and having a cross-section of a thin layer of woven vinyl, the seatbelt 12 includes a folded over cross-section, as illustrated in FIGS. 3B-3C. The seatbelt 12 may therefore be formed by utilizing a single layer of vinyl approximately twice the width of the conventional seatbelt 10, and folding the layer such that the lengthwise edges 14, 16 meet generally along the center-line of the seatbelt 12.

Alluding to the above, the edge 16 may be folded first, as illustrated in FIG. 3B, with the edge 14 thereby disposed outward of the edge 16. As shown in FIG. 3C, for example, the edge 14 may be folded first, with the edge 16 thereby disposed outward of the edge 14. The edges 14, 16 may then be stitched or otherwise attached together so that the outer sections 18, 20 of the seatbelt 12 are folded over as shown in FIGS. 3B or 3C thereby eliminating rough edges as presented by the conventional seatbelts 10.

In another exemplary embodiment, as shown in FIG. 3D, the seatbelt 12′ has the same width as the seatbelt 10 shown in FIG. 3A. However, instead of being formed of and having a cross-section of a thin layer of woven vinyl, the seatbelt 12′ includes a folded over cross-section FIG. 3D. The seatbelt 12′ may therefore be formed by utilizing two layers 22, 24 of vinyl each of at least the same width as the conventional seatbelt 10, and folding each layer 22, 24 at about a mid-point of each layer 22, 24. For example, the layer 24 may be folded first and the layer 22 may be folded around folded the layer 24. Accordingly, the lengthwise edges 26, 28 of the layer 24 may thus be enclosed within the lengthwise edges 30, 32 of the layer 24. Although not illustrated, one of ordinary skill in the art will recognize that the layer 22 may be folded first and the layer 24 may be folded around the folded layer 22 and remain within the spirit and scope of the present invention. Accordingly, the lengthwise edges 30, 32 of the layer 22 may thus be enclosed within lengthwise edges 26, 28 of the layer 24. The lengthwise edges 26, 28, 30, 32 may then be stitched or otherwise mechanically attached together so that the outer sections 18, 20 of the seatbelt 12′ are folded over as shown in FIG. 3D thereby eliminating rough edges as presented by the conventional seatbelts 10.

FIG. 3E presents a still another exemplary embodiment of the present invention. As shown in FIG. 3E, the seatbelt 12″ has the same width as the conventional known seatbelt 10. However, instead of being formed of and having a cross-section of a thin layer of woven vinyl, the seatbelt 12″ includes a folded over cross-section, as shown in FIG. 3E. The seatbelt 12″ may therefore be formed by utilizing a single tube 34 of vinyl that has no longitudinal edges. The tube 34 may be sewn or attached together at approximately a center 36 of the tube 34 as shown in FIG. 3E, so that the outer sections 18, 20 of the seatbelt 12″ are folded over as shown in FIG. 3E thereby eliminating rough edges as presented by the conventional seatbelts 10.

Compared to the seatbelt 10 of FIG. 3A, the seatbelts 12, 12′, and 12″ thus provide improved comfort due to the softness and resiliency of the outer folded sections 18, 20, rather than outer longitudinal edges of the conventional seatbelt 10. In the event of a crash, the seatbelts 12, 12′, and 12″ also provide superior safety as compared to seatbelt 10 by reducing the risk of the passenger's neck and/or shoulder-blade area to be burned, cut, or injured in any way due to the friction therebetween. The seatbelts 12, 12′, and 12″ are further advantageous because they do not require multiple components or inflation for operation. Accordingly, the inventive seatbelts have an increased life, a reduced cost, and a simpler manufacturing method.

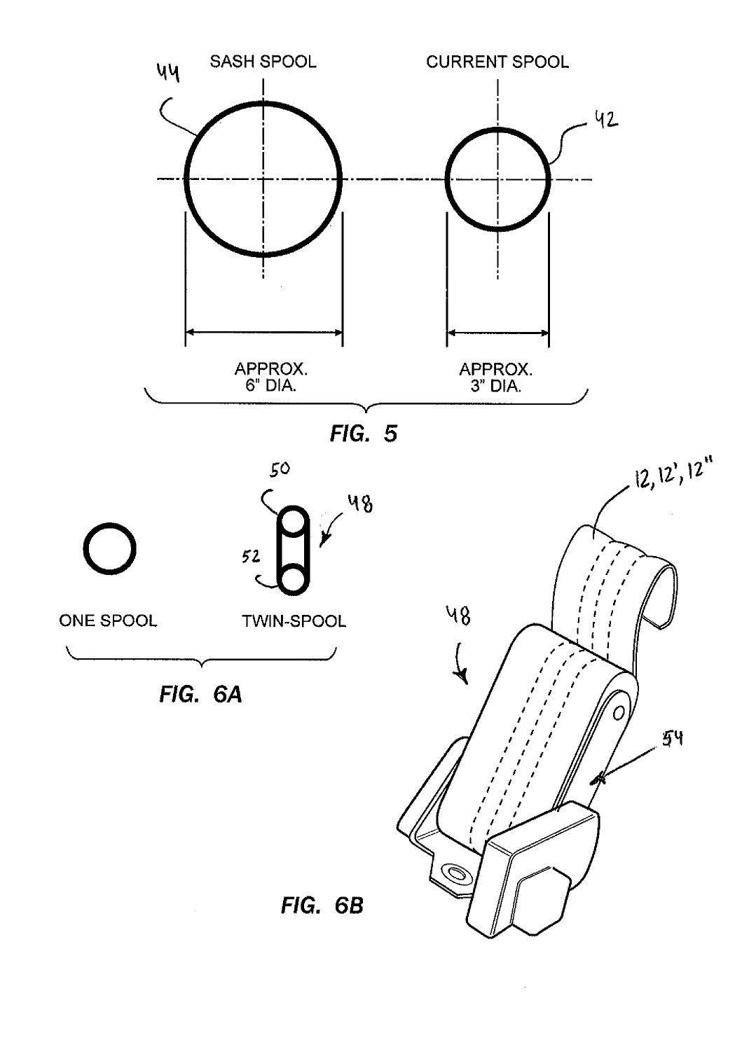

In another aspect of the present invention, the seatbelt 12, 12′, and 12″ is, at least partially, stored in a sash system, generally shown at 40 in FIG. 4. In a conventional sash system, a single spool 42 is used, as shown in FIG. 5. A typical spool 42 with a conventional seatbelt may have a diameter of approximately 3″. The seatbelt 12, 12′, 12″ of the present invention will generally have a larger diameter 44, e.g., 6″, due to the thickness of the seatbelt 12, 12′, 12″. The spool with the larger diameter 44 may be too large to fit into a package that can fit into an existing space.

In another embodiment as shown in FIG. 6, a twin spool design 48 is used. The twin spool design 48 has a first spool 50 and a second spool 52. The seatbelt 12, 12′, 12″ will generally be retracted or wound around both spools 50 and 52. In the illustrated embodiment, the twin spool design 48 includes a mounting bracket, generally indicated at 54. The mounting bracket 54 has a back wall 56 extending to a pair of parallel sides 58 and 60 extending substantially perpendicular to the back wall 56. The sides 58 and 60 extend to terminal ends 62 and 64 of one of the sides 58 and 66 and 68 of the other side 60. The terminal ends 62 through 68 present a semi-circular configuration.

Alluding to the above, a first plurality of pins 70 extend between the terminal end 62 of one side 58 to the terminal end 66 of the other side 60 to reduce friction of the belt 12. A second plurality of pins 72 extend between the terminal end 64 of one side 58 to the terminal end 68 of the other side 60 to reduce friction of the belt 12. A first or primary spool 74 extends between the sides 58 and 60 and between the first and second plurality of spools 70 and 72. The primary spool 74 is rotatable about a first axis A. An elongated slot 76 is defined in the primary spool 74 for the belt 12 to be fed therethrough and secured therein as the belt 12 is wound around the primary spool 74. A second or secondary spool 78 extends between the sides 58 and 60 and between the primary spool 74 and the second plurality of pins 72. The secondary spool 78 is rotatable about a second axis B. Actuators 80 and 82 are connected to the sides 58 and 60 to regulate the rotational mode of the primary spool 74. The actuators 80 and 82 include a spring that retracts the seatbelt 12, 12′, 12″ automatically and an inertia latch that provides a locking feature in a conventional manner. The bracket 54, the spools 74, 78, and the pins 70 and 72 are extruded from a polymeric material or may be fabricated from a metal or metal alloys by stamping, casting, or the like without limiting the scope of the present invention.

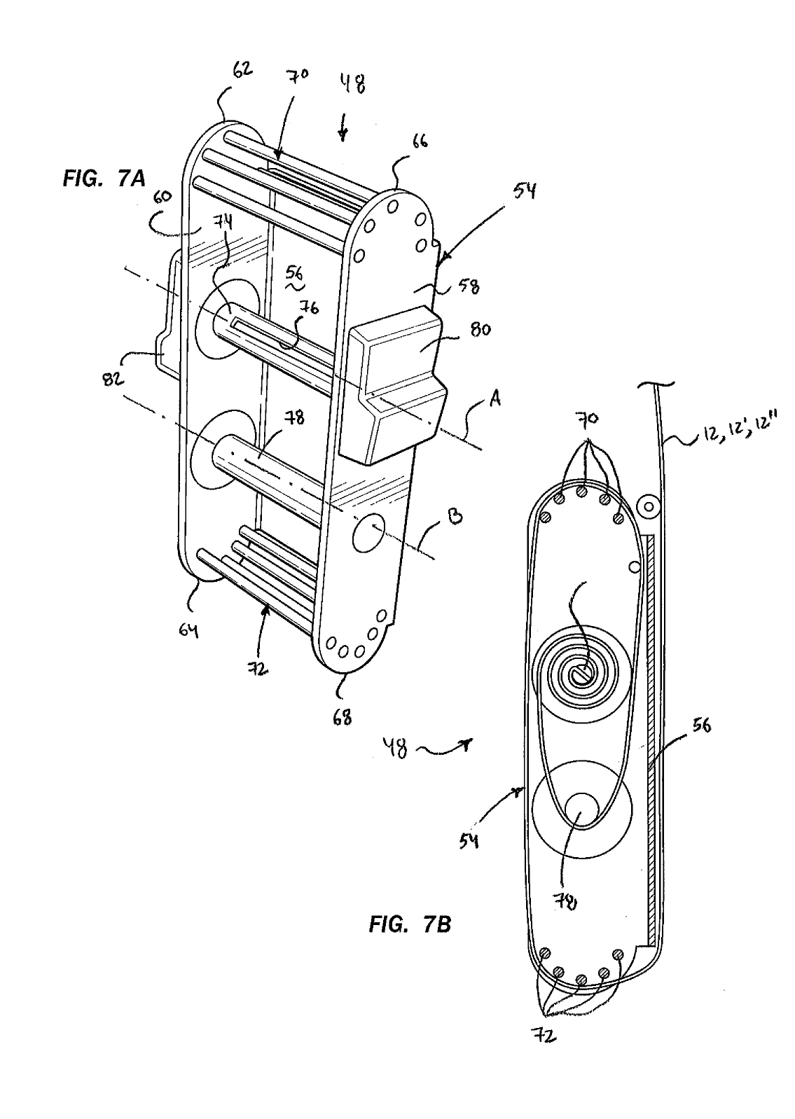

As best illustrated in FIG. 7B, the seatbelt 12, 12′, 12″ is fed through the elongated slot 76 of the primary spool 74 rotatable about the first axis A. The seatbelt 12, 12′, 12″ is wound around the primary spool 74 numerous times and then is wound once about the secondary spool 78. The seatbelt 12, 12′, 12″ is then fed about and supported by the first plurality of pins 70 and then in the similar fashion, the seatbelt 12, 12′, 12″ is then fed about and supported by the second plurality of pins 72. The seatbelt 12, 12′, 12″ is then directed up to a D-ring (not shown) and out of a B-pillar and out to the seat.

The multi-spool design of the present invention reduces the overall diameter of the wound seatbelt 12, 12′, 12″, thus, improving packaging characteristics. The overall diameter of the wound seatbelt 12, 12′, 12″ is affected by the spacing between the two spools 74 and 78, i.e., the further apart, the smaller the overall diameter. With an overall smaller diameter, the packaging can be smaller (thinner) and, thus, small enough to fit into the B-pillar or a seat system. The spools 74 and 78 and the pins 70 and 72 in combination with one another are close enough to concentrate the seatbelt 12, 12′, 12″ loads but far enough apart from one another to lessen the spool diameter for improved packaging.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A seatbelt device for retaining a belt of a seat assembly comprising;
a bracket presenting a back portion and a pair of side walls integrall with and extending generally perpendicular to said back portion with said side walls presenting a first terminal surface and a second terminal surface;
a first member rotatable about a first axis and extending between and interconnecting said side walls for retaining the first extremity of the belt therein; and
a second member interconnecting said side walls and rotatable about a second axis and extending between said first member and at least one of said first terminal surface and said second terminal surface for supporting the belt looped thereabout and movably supported by at least one of said first terminal surface and said second terminal surface as the belt is moved relative said bracket.

2. A seatbelt device as set forth in claim 1 wherein said first and second members are further defined by spools.

3. A seatbelt device as set forth in claim 1 wherein said first member includes a slot defined therein for retaining the first extremity of the belt.

4. A seatbelt device as set forth in claim 1 wherein said first terminal surface is further defined by a first plurality of pins extending between the terminal ends of said side walls and said second terminal surface is further defined by a second plurality of pins extending between the other terminal ends of said side walls for supporting the belt looped thereabout and movably supported thereon.

5. A seatbelt device as set forth in claim 1 wherein said bracket is formed from a polymeric material.

6. A seatbelt device as set forth in claim 1 wherein said bracket is formed from metal and metal alloys.

7. A seat assembly for a vehicle comprising;
a seat,
a bracket having terminal surfaces with said bracket being cooperable with said seat,
a belt extending through said bracket, and
a pair of members rotatable within said bracket with one of said members retaining the terminal end of said belt therein as said belt rotates about the other of said members and is movably supported by at least one of said terminal surface as said belt is moved relative said bracket.

8. A seat assembly as set forth in claim 7 wherein said bracket is further defined by a back portion and a pair of side walls integral with and extending generally perpendicular to said back portion with said side walls presenting said terminal surfaces.

9. A seat assembly as set forth in claim 7 wherein said pair of members are further defined by a first spool rotatable about a first axis and extending between and interconnecting said side walls to retain the terminal end of said belt.

10. A seat assembly as set forth in claim 7 wherein said pair of members are further defined by a second spool interconnecting said side walls and rotatable about a second axis and extending between said first member and at least one of said terminal surface for supporting said belt looped thereabout.

11. A seat assembly as set forth in claim 7 wherein said first spool includes a slot defined therein for retaining said belt.

12. A seat assembly as set forth in claim 7 wherein said terminal surfaces are further defined by a first plurality of pins extending between the terminal ends of said side walls and a second plurality of pins extending between the other terminal ends of said side walls for supporting said belt looped thereabout and movably supported thereon.

13. A seat assembly as set forth in claim 7 wherein said bracket is formed from a polymeric material.

14. A seat assembly as set forth in claim 7 wherein said bracket is formed from metal and metal alloys.
